(19) United States
(12) Patent Application Publication
(10) Pub. No.: US 2003/0029277 A1
(43) Pub. Date: Feb. 13, 2003

(54) Gasket tool for hose couplings

(76) Inventor: Mark G. Lummis, Mattawan, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/197,183

(22) Filed: Jul. 17, 2002

Related U.S. Application Data
(60) Provisional application No. 60/307,300, filed on Jul. 23, 2001.

(51) Int. Cl. B66F 1/00

(52) U.S. Cl. 81/8.1; 254/1

(57) ABSTRACT

A tool for inserting and removing gaskets from hose couplings includes a shaft having a nose and heel attached at one end of the shaft. The heel includes a flat, bottom surface that is pressed against the gasket in order to push the gasket into place. The heel may have a sufficiently large surface area to not cause undue markings or damage to the gasket when it is inserted. When the gasket is to be removed, the nose is inserted between an underside of the gasket and the gasket seat. The heel is then moved into contact with the gasket seat and used as a fulcrum by which the nose is lifted away from the gasket seat. This lifting movement causes the gasket to be lifted out of the hose coupling.

### BACKGROUND OF THE INVENTION

This invention relates generally to gaskets used in hose couplings and, more particularly, to an improved method and apparatus for inserting and removing such gaskets.

Hoses are used today in a wide variety of different industries ranging from water hoses for fighting fires, to gasoline hoses used for unloading gasoline trucks, to the many types of industrial hoses used for transporting liquid products during different manufacturing processes. Hose couplings are used to attach these hoses to other containers or structures. Most hose couplings include a gasket that helps prevent leakage of the liquid being pumped. The gasket is typically an O-shaped ring that is made from rubber or some other type of compressible material. The gasket is sandwiched between one end of the hose and a nozzle to which the hose is being attached. The compression of the gasket ensures a tight, and largely leak-proof, fit between the gasket and the nozzle.

In certain applications it is desirable, or even necessary, to repeatedly remove these gaskets from the hose couplings. For example, in situations where the hoses are being used to convey different types of liquids, it may be desirable to remove the gasket in order to clean or replace it prior to re-using the hose for transporting a different type of liquid. Such cleaning or replacement helps prevent contamination of subsequent liquids that are transported using the same hose and coupling. The prevention of such contamination can be especially important in instances where the liquids being pumped through the hoses are pharmaceutical products, food products, or other types of products which must be kept germ-free or contaminant-free. In other situations, it may be important to frequently change the gaskets because the material of certain ones of the gaskets may be reactive with certain ones of the liquids being pumped, and the gaskets may require changing in order in order to avoid these undesirable reactions. In still other situations, the gasket may have to be replaced simply because it has worn out or because it needs to be cleaned or sterilized. The desire or need to change gaskets in hose couplings therefore arises in a variety of situations, including those in which such changes are needed frequently.

In the past, the changing of gaskets has not been without several difficulties. The gaskets are often difficult to remove because the pressure that is applied to them when coupled to a nozzle tends to tightly sandwich them within the hose coupling. This sandwiching can cause the gasket to stick to the coupling even after the coupling has been de-coupled from the nozzle. While this can be overcome by inserting a screwdriver or pliers into the coupling to dislodge the gasket, the use of these tools also has certain disadvantages. Often these tools will damage the gasket during its removal, thereby diminishing the effectiveness of the gasket or causing the gasket to have to be discarded altogether. The use of screwdrivers or pliers also ends up occasionally causing nicks or gouges on the interior surfaces of the hose couplings. This type of damage can necessitate having to completely discard an expensive hose coupling. Nicks and gouges on either the hose coupling or gasket can also create fragments of material that may need to be removed in order to prevent contamination. Such removal only further adds to the costs and difficulties of changing gaskets.

The difficulties associated with removing a gasket are also often present when first inserting the gasket. Screwdrivers or pliers tend to be used for this insertion process as well, leading to the above-noted problems.

In light of the foregoing, the need can be seen for a way of simplifying the gasket insertion and removal process.

### SUMMARY OF THE INVENTION

Accordingly, the present invention provides an improved method and apparatus for inserting and removing gaskets from hose couplings. The apparatus is specially designed for both inserting and removing gaskets and is less prone to causing damage to either the gasket or the hose coupling. This reduces the number of gaskets or hose couplings that may have to be discarded. The gasket changing process can thus be carried out in a more economical and efficient manner.

According to one aspect of the present invention, a gasket removal tool is provided for removing gaskets from hose couplings. The gasket removal tool includes a shaft, a nose, and a generally planar heel. The nose is attached to, and extends forwardly from, a first end of the shaft. The heel is attached to, and extends rearwardly from, the first end of the shaft. The shaft and heel are arranged such that when the shaft is pivoted rearwardly, the nose moves in an opposite direction as the heel.

According to another aspect of the present invention, a gasket removal tool is provided that includes a shaft, a nose, and a heel. The nose is attached to a first end of the shaft and has a generally flat top surface and a generally flat bottom surface. The nose is dimensioned to be inserted between the gasket to be removed and the gasket seat against which the gasket sits. The heel is attached to the first end of the shaft and is dimensioned larger than an inner diameter of the gasket seat. The heel includes a generally flat bottom surface.

According to another aspect of the invention, a tool for manipulating gaskets within a cylindrical hose coupling is provided. The tool includes a shaft and a heel attached at one end to the shaft. The heel has a generally flat bottom surface and an edge adjacent the flat bottom surface. The edge includes at least a portion that is arced. The arced portion has a radius of curvature equal to or less than half of an inside diameter of the gasket after the gasket has been compressed by the attachment of the hose coupling to a nozzle.

According to still another aspect of the present invention, a method is provided for removing a gasket from a hose coupling wherein the gasket is positioned next to a gasket seat. The method includes providing a shaft having a flange attached at one end. The flange includes a first end and a second end positioned away from the first end. The flange is inserted into the hose coupling toward the gasket and the first end of the flange is positioned between the gasket and a portion of the gasket seat. The second end of the flange is then positioned against at least a portion of the seat. The shaft is pivoted such that the first end of the flange and a portion of the gasket are lifted away from the seat while the second end remains substantially in contact with the seat. The first and second ends of the flange are then moved away from the gasket seat.

According to yet another aspect of the present invention, a method is provided for inserting a gasket into a hose coupling and positioning the gasket against a gasket seat within the hose coupling. The method includes providing a shaft having a flange attached at one end. The flange includes an arced edge and a generally flat bottom surface adjacent the arced edge. The gasket and the shaft are inserted into an end of the hose coupling. The generally flat bottom surface of the flange is moved into contact with at least a portion of the gasket and then is pushed down against the gasket to cause the gasket to be moved into abutment with the gasket seat.

In still other aspects of the invention, the heel of the tool may include an outer perimeter that is generally semicircular, and which may have a radius that is less than or equal to the inner radius of the gasket to be removed or inserted. The nose and heel may also both be generally planar and attached to the shaft at a non-right angle. The tool may further include a second heel and second nose attached to the shaft at an end opposite the first heel and nose. The front of the nose may also be beveled, and the entire tool may be made of a material that can be sterilized, such as stainless steel.

The methods and apparatuses of the present invention provide a way of manipulating gaskets that avoids many of the disadvantages of the past. The gasket tool reduces the damage caused to the gaskets and the hose couplings while providing an easy and efficient manner for inserting and removing gaskets. The attendant labor and material costs associated with past methods and devices for changing gaskets is therefore greatly reduced. These and other advantages of the present invention will be apparent to one skilled in the art in light of the following specification when read in conjunction with the accompanying drawings.

### BRIEF DESCRIPTION OF THE DRAWINGS

FIG. 1 is a side elevational of a gasket tool according to one aspect of the invention;

FIG. 1A is a perspective view of the tool of FIG. 1;

FIG. 2 is a plan view of a first nose and a first heel attached to a first end of the tool of FIG. 1;

FIG. 3 is a plan view of a second nose and a second heel attached to a second end of the tool of FIG. 1;

FIG. 4 is a side elevation of an illustrative hose coupling and nozzle on which the present invention finds application shown prior to their connection;

FIG. 5 is a side elevation of the hose coupling and nozzle of FIG. 4 attached together;

FIG. 6 is an exploded, side elevation of a hose coupling assembly, gasket, and nozzle on which the present invention finds application;

FIG. 7 is a side, sectional view of a hose coupling assembly, gasket tool, and a gasket being inserted into the hose coupling;

FIG. 8 is a side, sectional view of the hose coupling assembly and gasket of FIG. 7 secured to a nozzle;

FIG. 9 is a side, sectional view of the hose coupling assembly, gasket, and gasket tool of FIG. 7 illustrating a nose of the gasket tool inserted between the gasket and a gasket seat at the beginning of removal of the gasket from the hose coupling assembly;

FIG. 10 is a side, sectional view of the hose coupling assembly, gasket, and gasket tool of FIG. 7 illustrating the heel of the gasket tool abutting the gasket seat during the gasket removal process;

FIG. 11 is a side, sectional view of the hose coupling assembly, gasket, and gasket tool of FIG. 7 illustrating the gasket tool being pivoted rearwardly to lift the gasket to complete the removal of the gasket; and

FIG. 12 is a partial sectional view of a gasket tool according to another embodiment of the present invention.

### DETAILED DESCRIPTION OF THE PREFERRED EMBODIMENTS

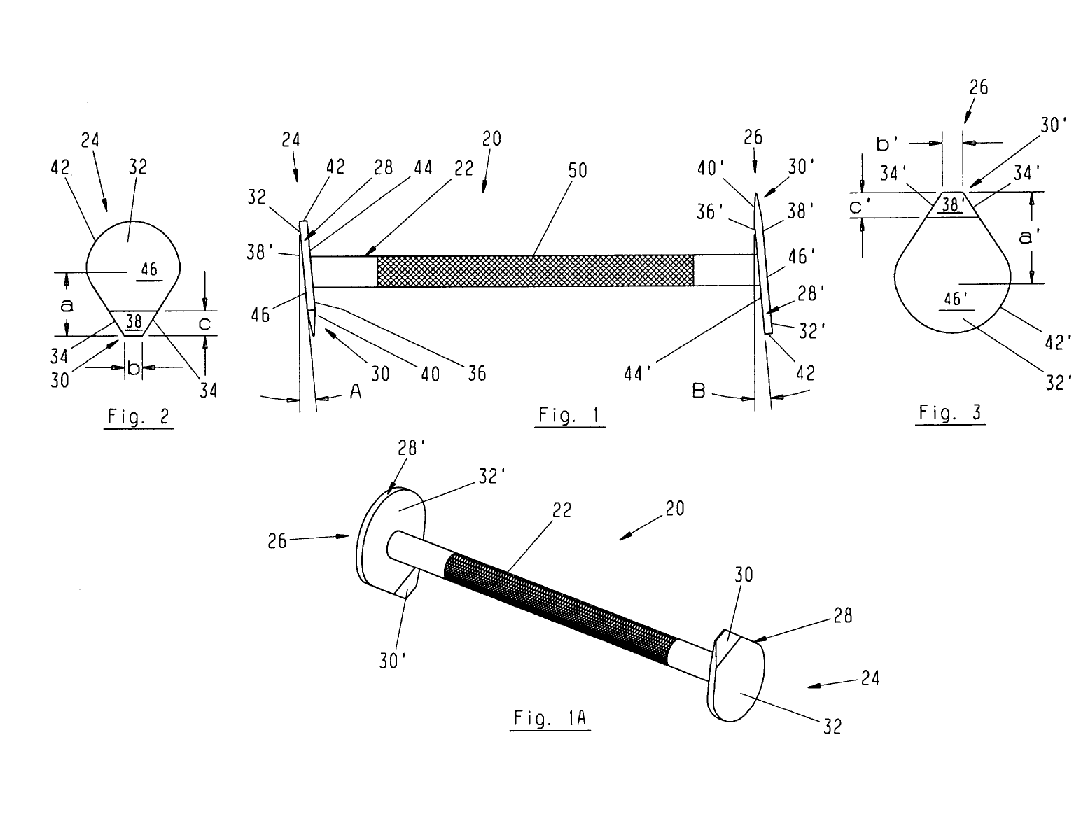

The present invention will now be described with reference to the accompanying drawings wherein like reference numerals correspond to like elements in the several drawings. A gasket tool 20 according to one embodiment of the present invention is depicted in FIGS. 1 and 1A. Gasket tool 20 includes an elongated shaft 22 having a first end 24 and a second end 26. A flange 28 is attached to shaft 22 at first end 24. Flange 28 includes a nose 30 and a heel 32. Nose 30 and heel 32 extend outwardly from shaft 22 in opposite directions. Nose 30 is used primarily during the removal of a gasket from a hose coupling, while heel 32 is used during both the insertion and removal process, as will be explained in more detail below.

Nose 30 includes two sides 34 which angle toward each other as they extend forwardly from shaft 22. Nose 30 further includes a top surface 36 and a bottom surface 38 which are generally flat or planar. A beveled tip 40 may also be provided at the front end of nose 30. Beveled tip 40 facilitates insertion of nose 30 between a gasket and a seat against which the gasket rests, as detailed further below. Nose 30 is, therefore, preferably dimensioned to be relatively thin with planar surfaces which taper toward one another to form beveled tip 40, although other shapes from that depicted in the accompanying drawings are possible. While nose tip 40 is beveled for easier insertion underneath a gasket, it is preferably not beveled to such a degree as to produce a sharp edge that is capable of easily cutting into, and damaging, the gasket. While other dimensions can be used, nose tip 40 may have a height of 1/64th of an inch at its outer end, which is generally suitable for avoiding undue damage to the gasket.

Heel 32 extends rearwardly from shaft 22 in opposition to nose 30, a top surface 44 and a bottom surface 46. Top and bottom surfaces 44 and 46 are generally planar and parallel in the illustrated embodiment, and terminate at an edge 42. Edge 42, when viewed from above or below, is generally semicircularly shaped. This semicircular shape defines a radius that extends outwardly from the center of shaft 22 to edge 42. This radius is preferably, although not necessarily, less than or equal to the inside radius of the gasket to be removed after the gasket has been compressed. By being less than or equal to the inside radius of the gasket, heel 32 is free to be inserted through the open center of the O-shaped gasket. During use, the gasket is typically compressed between the gasket seat and the nozzle to which the hose coupling is attached. This compression often tends to squeeze the gasket, both radially inwardly and outwardly, thereby reducing the measured inside radius of the gasket. In order to ensure that heel 32 can fit through this reduced radius gasket, the semicircular portion of heel 32 should be less than or equal to this compressed radius. The radius of the semicircular portion of edge 42 should also be greater than an inside radius of the gasket seat in order to allow the heel to abut against the gasket seat during the removal of the gasket, as discussed further below. Edge 42 of heel 32 may be altered from that depicted in the attached drawings to include a curvilinear or arced portion that is greater than or less than a true semicircle (half of a circle). While some portion of an arc is preferred, edge 42 of heel 32 may also be further modified to be non-arced, either partially or wholly.

In the illustrated embodiments, nose 30 and heel 32 are generally co-planar. Nose 30 and heel 32 are preferably, although not necessarily, attached to shaft 22 at an angle A which is a non-right angle (i.e. not 90°; see FIG. 1). Angle A is preferably about five degrees, although wide variations from this angular measurement can be used within the scope of the invention. The angular measure of angle A is generally only limited to that which will allow shaft 22 and flange 28 to still be fully inserted into a hose coupling and used to manipulate a gasket. The angle between shaft 22 and flange 28 is also preferably chosen such that an acute angle is formed between shaft 22 and nose 30, and an obtuse angle is formed between shaft 22 and heel 32. Angle A facilitates removal of a gasket by allowing shaft 22 to be pulled rearwardly to a greater extent, to thereby lift the gasket out of the hose coupling, as described in more detail below.

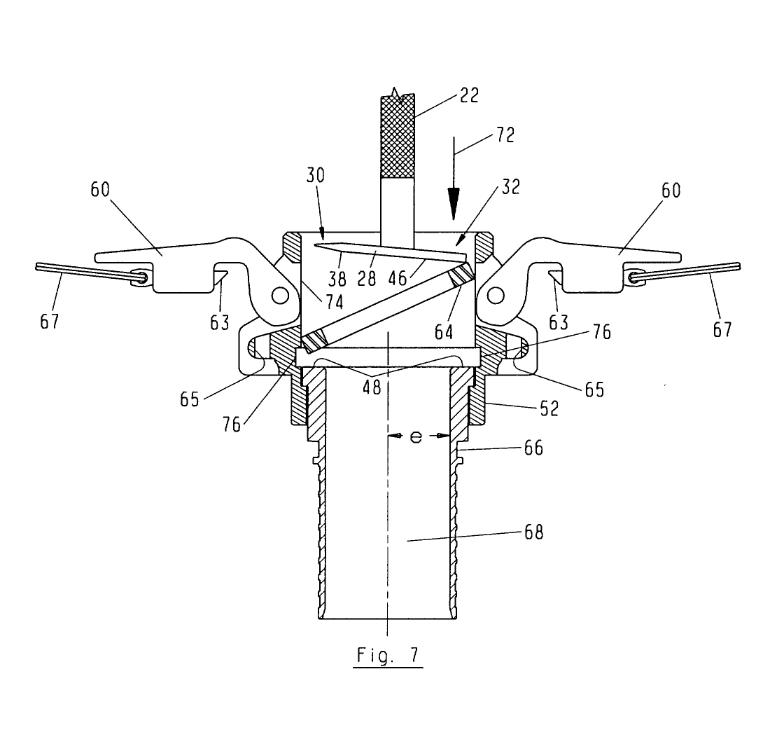

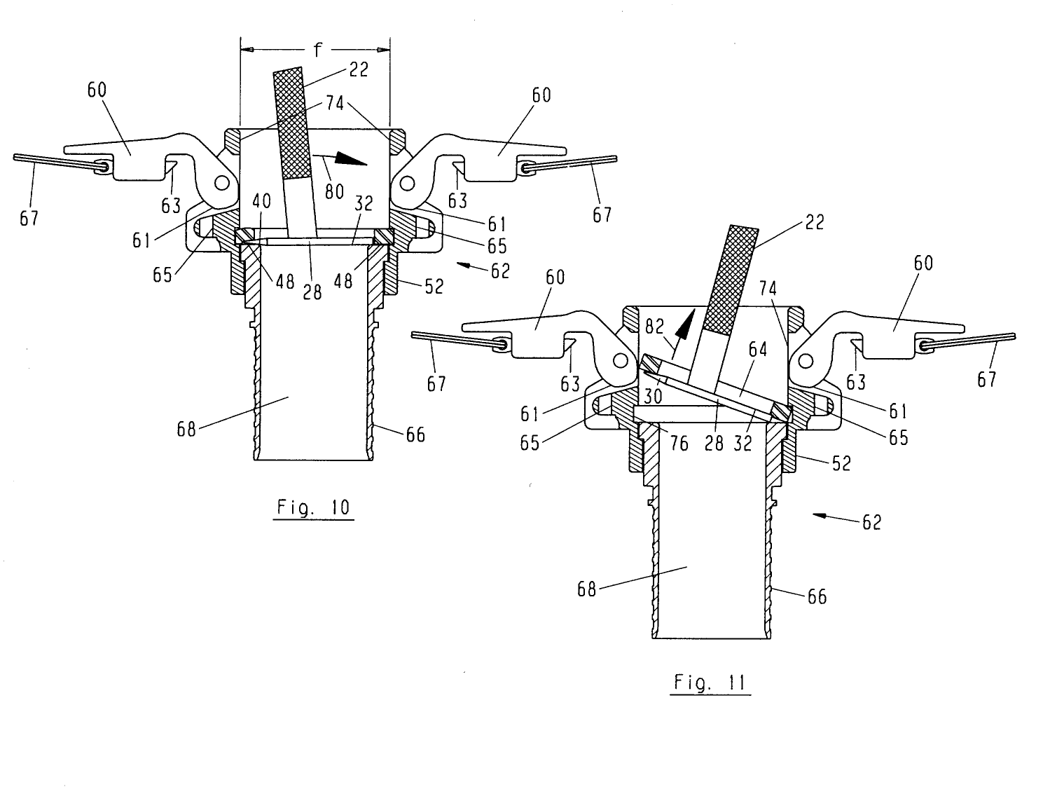

Second end 26 of shaft 22 includes another or second flange 28′ having a nose 30′ and a heel 32′ that are the same in all respects to flange 28, nose 30, and heel 32 with the sole exception of their dimensions. Flange 28 is specifically dimensioned to be used with gaskets and hose couplings of a particular size while flange 28′ is dimensioned to be used with gasket and hose couplings of a different size. By combining flanges 28 and 28′ onto the same shaft 22, a single tool 20 can be used with gaskets and hose couplings of two different sizes. While the dimensions can vary from those described herein, flange 28 is dimensioned to be used with a one and one-half inch hose coupling (which refers to the inside diameter of the gasket). The radius of heel 32 is 0.750 inches as measured from the center of shaft 22 to semicircular edge 42. The distance from the center of shaft 22 to the tip of nose 30 (dimension a in FIG. 2) is 1.062 inches; the width of the tip of nose 30 (dimension b) is 0.312 inches; and the length of the beveling of nose 30 (dimension c) is 0.375 inches. These exact dimensions are not critical to the invention, but can be changed considerably. It is, however, preferable to have the radius of heel 32 be less than or equal to the inside radius of the gasket, as discussed above. Also, it is preferable to have the radius of heel 32 be slightly larger than the inside radius of a gasket seat 48 (dimension e in FIG. 7) in order to allow heel 32 to abut against gasket seat 48. Further, it is preferable to have the total length from the tip of nose 30 to the back of edge 42 be less than the distance from the inside of the gasket to an opposite inside surface 74 of the hose coupling (dimension f in FIG. 10). This ensures that flange 28 is sufficiently small to be initially inserted under a portion of the gasket. In addition to variations in the above-described dimensions, the shapes of nose 30 and heel 32 can be varied considerably from that depicted in the drawings.

Flange 28′ is dimensioned to be used with a two inch hose coupling. With reference to FIGS. 1 and 3, flange 28′ includes a radius of semicircular edge 42′ that is 0.937 inches. The distance from the center of shaft 22 to the tip of nose 30′ (dimension a′) is 1.250 inches; the width of the tip of nose 30′ (dimension b′) is 0.312 inches; and the length of the beveling of nose 30′ (dimension c′) is 0.375. The length of beveling of nose 30′ is the same as that for nose 30, and generally corresponds to the thickness of the gasket being used. In addition to flanges 28 and 28′, tool 20 can be used with other flanges of different shapes and sizes. The multiple different flanges can be combined onto a single shaft 22 in any desired combination, or they can be mounted to only a single end of the shaft. Flange 28′ is attached to shaft 22 at an angle B, which is preferably the same as angle A, although other angular relationships between shaft 22 and flange 28′ can be used. Flange 28′ may be oriented to face in an opposite direction of flange 28 and parallel thereto, or it may be attached in other orientations.

If it is desired to have a tool 20 that includes a flange 28 dimensioned to be used with a one inch hose coupling, such a flange might include a radius of 0.468 inches. It further might include a length from the center of the attached shaft to the nose tip of 0.718 inches; a tool tip width of 0.312 inches; and a bevel having a length of 0.375 inches. As noted above, such dimensions are illustrative only.

Shaft 22 of tool 20 further includes a knurled surface portion 50 between first and second ends 24 and 26. Knurled portion 50 helps prevent a user's hand from slipping when using tool 20, especially when the person is wearing gloves or the tool is wet. While other dimensions may be used, shaft 22 may have a diameter of 0.5 inches and a length of seven inches.

Tool 20 is preferably made entirely of a material that can be sterilized in order for it to be used in sterile applications. Tool 20 is also preferably made from a material that is relatively inert so that it will not react with any residue from a wide variety of liquids that are pumped through the hose coupling. Although other materials may be used, tool 20 is preferably made of stainless steel. Tool 20 could alternatively be made of anodized aluminum, a hard nylon, a carbon steel, or other material. Flanges 28 and 28′ may be seam welded onto shaft 22, or secured thereto via other means.

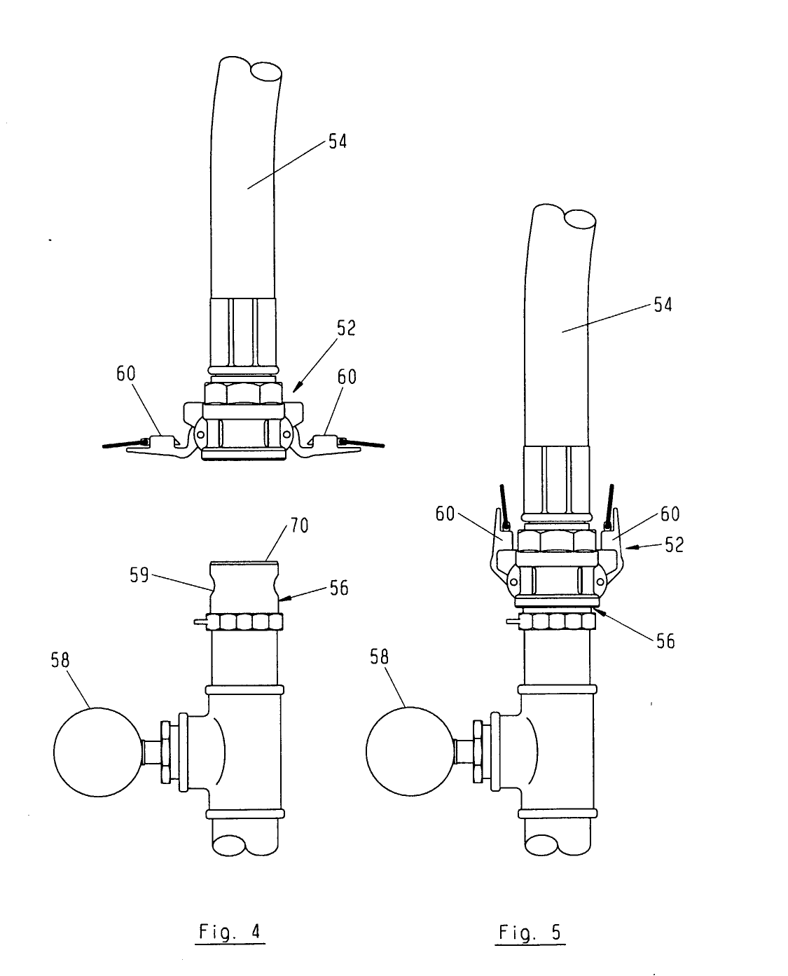

The operation and use of tool 20 will now be described with reference to FIGS. 4-11. An illustrative example of a hose coupling 52 to which the present invention finds application is depicted in FIGS. 4-5. Hose coupling 52 may be a Kamlok™ cam and groove quick disconnect hose coupling sold by Civacon of Kansas City, Mo., or it may be another type of hose coupling. Hose coupling 52 is attached to a hose 54 at one end and is selectively attachable and detachable to a nozzle 56 at its other end. Nozzle 56 may be permanently attached to a tank, another hose, or some other structure, by way of internal threads 57. In some applications, a gauge 58 may be attached near nozzle 56. Hose coupling 52 is selectively locked onto nozzle 56 by way of a pair of locking arms 60. Locking arms 60 are movable between an unlocked position (FIG. 4) and a locked position (FIG. 5). When hose coupling 52 is attached to nozzle 56 and locking arms 60 are in their locking position, a liquid-tight seal is formed between hose 54 and nozzle 56.

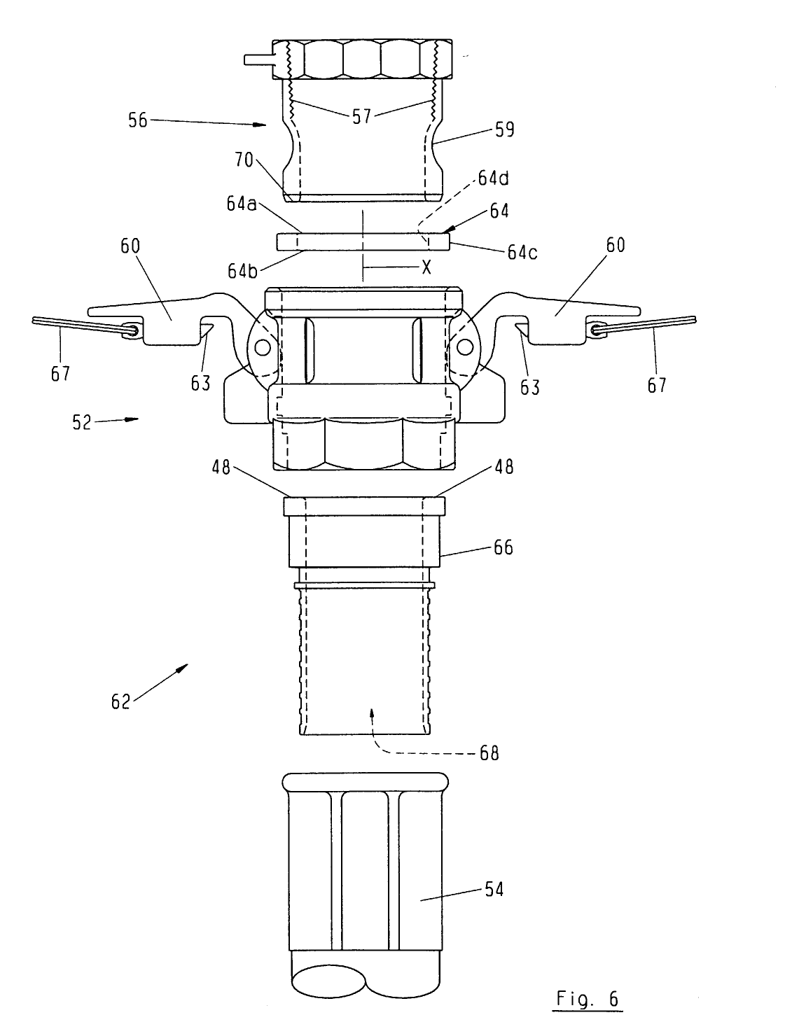

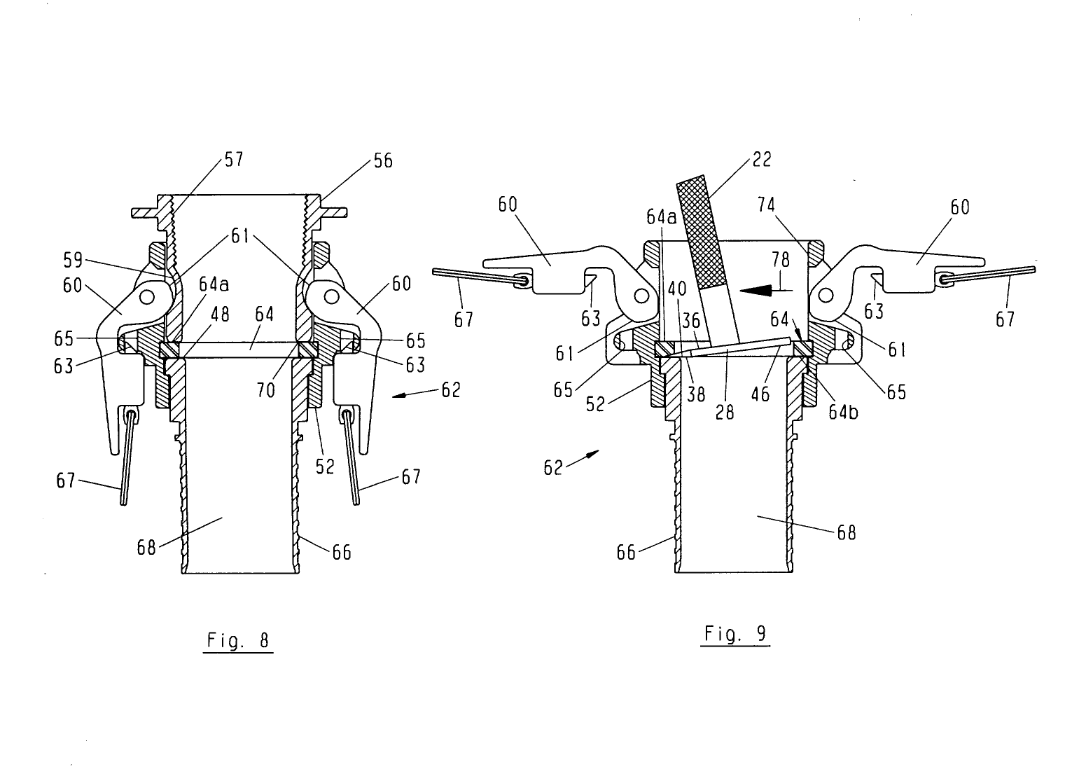

FIG. 6 depicts in more detail a hose coupling assembly 62 including nozzle 56, hose 54, a hose coupling assembly 62, and a gasket 64. Hose coupling assembly 62 includes hose coupling 52 and a hose insert or barb 66 which fits partially inside of hose 54. Hose insert 66 is generally cylindrical in shape and includes an internal passageway or bore 68 through which the liquid being transported can flow. Gasket seat 48 is defined at the top end of hose insert 66 and contacts gasket 64 when gasket 64 has been inserted into hose coupling 52. Gasket 64 is a generally O-shaped ring or annulus and preferably has generally planar and parallel radial surfaces 64a, 64b and generally parallel axial surfaces 64c, 64d which are also parallel to the central axis x of the gasket. As is best seen in FIG. 8, gasket 64 is sandwiched between an end 70 of nozzle 56 and gasket seat 48 when hose coupling 52 locks nozzle 56 to hose insert 66. FIG. 8 illustrates gasket 64 in its operational position with hose insert 66 secured to nozzle 56 by way of hose coupling 52.

The use of tool 20 to insert gasket 64 into hose coupling 52 is illustrated in FIG. 7. Gasket 64 is initially inserted part-way into hose coupling 52 by hand or other means. Because of its size relative to hose coupling 52, gasket 64 often initially goes into hose coupling 52 at an angle, as illustrated in FIG. 7. Regardless of its orientation, gasket 64 can be more easily inserted into its operational position by way of heel 32 of tool 20. Heel 32 is pressed against a top end of gasket 64 and pushed downward in a direction illustrated by the arrow 72 of FIG. 7. Because heel 32 has a generally flat bottom surface 46, it does not gouge or mar gasket 64 when used to push gasket 64. Further, because heel 32 has a generally semi-circular edge 42, this edge will not easily mar or otherwise damage an internal surface 74 of hose coupling 52, even if this edge remains in contact with surface 74 while pushing gasket 64 into place. Once pushed fully into place (FIG. 8), gasket 64 abuts against gasket seat 48 and will rest in a gasket groove 76 defined inside of hose coupling 52.

Hose coupling 52 may then be attached to nozzle 56. This is accomplished by inserting end 70 of nozzle 56 into the open end of hose coupling 52 until end 70 engages the partially exposed upper surface 64a of gasket 64. Locking arms 60 are then rotated from the position shown in FIG. 7 to that shown in FIG. 8 such that the rounded ends 61 of locking arms 60 are received in curved, annular recess 59 of nozzle 56. Ends 61 prevent axial removal of nozzle 56 from hose coupling 52 until both arms 60 are unlocked by retraction of spring-biased locking members 63 from openings 65 (FIGS. 7-11) via pull rings 67, whereby the arms can be rotated to the release position of FIG. 7.

The removal of gasket 64 from hose coupling 52 is illustrated in FIGS. 9-11. After tool 20 has been inserted into the internal bore of hose coupling 52, nose 30 is inserted underneath a portion of gasket 64 (FIG. 9). More specifically, nose 30 is inserted between gasket seat 48 and an adjacent underside 64b of gasket 64. The beveling of nose 30 facilitates this insertion. Insertion of nose 30 is accomplished by moving tool 20 in the direction indicated by arrow 78. After nose 30 has been inserted underneath surface 64b of gasket 64, heel 32 is lowered into contact with gasket seat 48 (FIG. 10). Because heel 32 has a radius larger than the inside radius of gasket seat 48, but equal to or smaller than the inside diameter of gasket 64, it cannot be inserted past gasket seat 48. With the rear portion of heel 32 contacting gasket seat 48, heel 32 acts like a fulcrum while shaft 22 is pivoted in the direction indicated by arrow 80 (FIG. 10). This pivoting of shaft 22 causes nose 30 to be lifted upwardly and away from gasket seat 48. Because nose 30 is positioned underneath a portion of gasket 64, this lifting also causes gasket 64 to be partially expelled from gasket groove 76 (FIG. 11). The angle A which defines the angular relationship between shaft 22 and flange 28 facilitates this pivoting by providing additional space between shaft 22 and the interior surface 74 of hose coupling 52 at a position opposite nose 30. Thus, by being attached at an angle, more space is created between shaft 22 and a rearward portion of internal surface 74 of hose coupling 52. Shaft 22 can therefore be pivoted to a greater extent before coming into contact with surface 74. This greater amount of pivoting makes it easier to partially lift gasket 64 out of gasket groove 76. After shaft 22 has been pivoted, gasket 64 is fully removed from hose coupling 52 by further retracting tool 20 out of hose coupling 52 while maintaining at least a portion of flange 28, such as nose 30, underneath gasket 64. This motion is indicated in FIG. 11 by arrow 82.

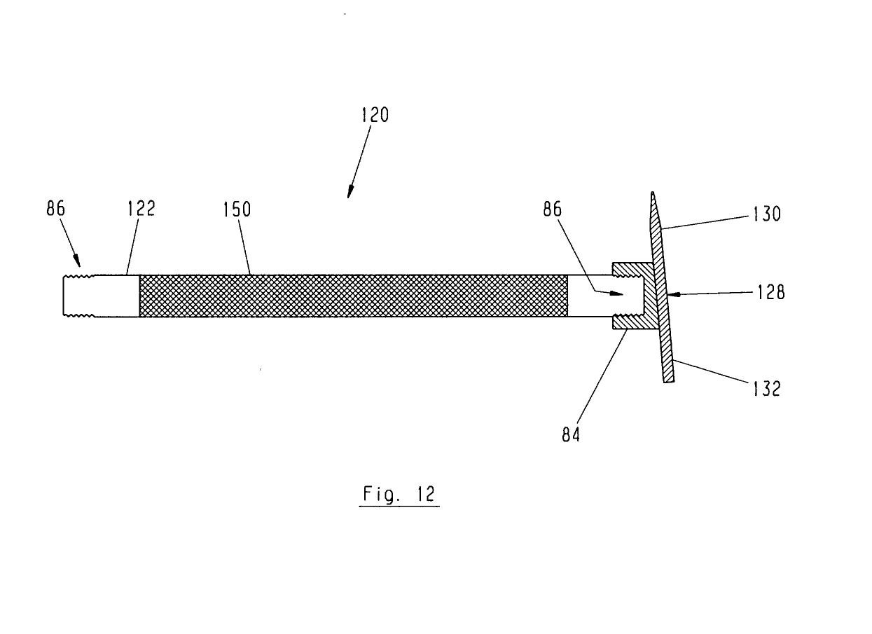

A tool 120 according to a second embodiment of the present invention is depicted in FIG. 12. The parts of tool 120 corresponding to those of tool 20 are identified with the same numbers increased by one hundred. Tool 120 is the same as tool 20 in all respects except for the manner by which flange 128 is connected to shaft 122. Flange 128 is detachable from shaft 122, allowing different sized flanges to be used with a single shaft. Flange 128 includes an internally threaded collar 84 which can be screwed onto an externally threaded end 86 of shaft 122. By using a variety of differently sized flanges 128, a single shaft 122 can be used in combination with one or two selected flanges 128 to insert and remove gaskets of any size. Users of tool 120 who use hose couplings of more than two different sizes therefore wouldn't have to purchase multiple separate tools 20, but instead could purchase a shaft 120 and as many individual flanges 128 as necessary to accommodate all the differently sized hose couplings. The manner of using tool 120 after a flange 128 has been secured to an end 86 is the same in all respects to that of tool 20, described above.

While the present invention has been described in terms of the preferred embodiments depicted in the drawings and discussed in the above specification, along with several alternative embodiments, it will be understood by one skilled in the art that the present invention is not limited to these particular embodiments, but includes any and all such modifications that are within the spirit and the scope of the present invention as defined in the appended claims.

What is claimed is:

1. A tool for manipulating a gasket in a hose coupling comprising:
a shaft;
a nose attached to, and extending forwardly from, a first end of said shaft; and
a heel attached to, and extending rearwardly from, said first end of said shaft;
said shaft and heel being arranged such that when said shaft is pivoted rearwardly, said nose moves in an opposite direction as said heel.

2. The tool of claim 1 wherein said heel has an outer perimeter that is generally semicircular.

3. The tool of claim 2 wherein said heel is generally planar.

4. The tool of claim 3 wherein said generally semicircular perimeter of said heel has a radius that is less than or equal to an inner radius of the gasket to be removed.

5. The tool of claim 1 wherein said nose and said heel are both generally planar and said shaft is attached to said nose and said heel at a non-right angle.

6. The tool of claim 5 wherein said shaft is attached to said nose such that an acute angle is formed between said shaft and said nose and an obtuse angle is formed between said shaft and said heel.

7. The tool of claim 1 wherein said shaft, said nose, and said heel are all made of material that can be sterilized.

8. The tool of claim 7 wherein said shaft, said nose, and said heel are all made from stainless steel.

9. The tool of claim 1 wherein said shaft includes a knurled surface defined along at least a portion of said shaft.

10. The tool of claim 1 further including a second nose and a second heel attached to said shaft at a second end opposite said first end.

11. The tool of claim 10 wherein said second nose and said second heel are oriented substantially parallel to said nose and said heel.

12. The tool of claim 1 wherein said nose includes two side edges which are angled toward each other and which join a front edge.

13. The tool of claim 1 wherein said nose extends forwardly from said shaft by a first distance, said heel extends rearwardly from said shaft by a second distance, and said first distance is greater than said second distance.

14. The tool of claim 1 wherein said nose includes a beveled tip.

15. The tool of claim 1 wherein said nose and heel are adopted to be attached and detached from said shaft.

16. The tool of claim 14 wherein said nose is beveled for a distance greater than or equal to the width of the gasket to be removed.

17. A tool for manipulating a gasket in a hose coupling wherein the hose coupling includes a seat against which the gasket rests when the gasket is in an operational position, said tool comprising:
a shaft;
a nose attached to a first end of said shaft, said nose having a generally flat top surface and a generally flat bottom surface, said nose being dimensioned to be inserted between the gasket to be removed and the seat against which the gasket sits; and
a heel attached to said first end of said shaft away from said nose, said heel being dimensioned larger than an inner diameter of the seat, said heel having a generally flat bottom surface.

18. The tool of claim 17 wherein said heel has an outer perimeter that is generally semicircular.

19. The tool of claim 18 wherein said generally semicircular perimeter of said heel has a radius that is less than or equal to an inner radius of the gasket to be removed.

20. The tool of claim 18 wherein said generally semicircular perimeter of said heel has a radius that is greater than an inner radius of the seat.

21. The tool of claim 17 wherein said nose and said heel are each generally planar, are generally co-planar with respect to each other, and are connected to each other.

22. The tool of claim 21 wherein said shaft is attached to said nose and said heel at a non-right angle such that an acute angle is formed between said shaft and said nose and an obtuse angle is formed between said shaft and said heel.

23. The tool of claim 17 wherein said shaft, said nose, and said heel are all made of material that can be sterilized.

24. The tool of claim 17 wherein said shaft includes a knurled surface defined along at least a portion of said shaft.

25. The tool of claim 17 further including a second nose and a second heel attached to said shaft at a second end opposite said first end of said shaft.

26. The tool of claim 25 wherein said second nose and said second heel are oriented substantially parallel to said nose and said heel.

27. The tool of claim 17 wherein said nose includes two side edges which are angled toward each other and which join a front edge.

28. The tool of claim 17 wherein said nose includes a beveled tip.

29. The tool of claim 15 wherein said nose and said heel are adapted to be attached and detached from said shaft.

30. The tool of claim 29 further including a collar attached to said nose and said heel and adopted to be releasably screwed to an end of said shaft.

31. The tool of claim 28 wherein said nose is beveled for a distance greater than or equal to the width of the gasket to be removed.

32. The tool of claim 17 wherein said nose extends forwardly from said shaft by a first distance, said heel extends rearwardly from said shaft by a second distance, and said first distance is greater than said second distance.

33. A tool for manipulating gaskets within a cylindrical hose coupling wherein the gasket rests against a gasket seat when inserted into the hose coupling, said tool comprising:
a shaft; and
a heel attached at one end to said shaft, said heel having a generally flat bottom surface and an edge adjacent said flat bottom surface, said edge being arced along at least a portion thereof and having a radius of curvature equal to or less than half of an inside diameter of the gasket after the gasket has been compressed by the attachment of the hose coupling to a nozzle.

34. The tool of claim 33 wherein said heel is attached to said shaft such that said generally flat bottom surface forms a non-right angle with respect to said shaft.

35. The tool of claim 34 wherein said heel is attached to said shaft such that said generally flat bottom surface forms an angle between 85 and 110 degrees with respect to said shaft.

36. The tool of claim 33 wherein said heel is adapted to be attached and detached from said shaft.

37. The tool of claim 33 further including a second heel attached to said shaft at an end opposite said heel.

38. The tool of claim 33 further including a nose attached to said shaft opposite said heel, said nose being dimensioned to fit between the gasket seat and a gasket abutting the gasket seat.

39. The tool of claim 38 wherein said nose extends from said shaft a first distance, said heel extends from said shaft by a second distance, and said first distance is greater than said second distance.

40. The tool of claim 39 wherein said nose includes a beveled tip.

41. A method of removing a gasket from a hose coupling wherein the gasket is positioned next to a gasket seat, said method comprising:
providing a shaft having a flange attached at one end, said flange having a first end and a second end, said second end being positioned away from said first end;
inserting said flange into said hose coupling toward said gasket;
positioning said first end of said flange between the gasket and a portion of the gasket seat;
positioning said second end of said flange against at least a portion of said seat;
pivoting said shaft such that said first end of said flange and a portion of the gasket is lifted away from said seat while said second end remains substantially in contact with said seat; and
moving said first end and said second end of said flange away from said gasket seat.

42. The method of claim 41 further including:
providing a second flange attached at another end of said shaft, said second flange being dimensioned differently from said flange;
selecting between said flange and said second flange; and
using the selected flange to remove the gasket.

43. The method of claim 41 wherein said gasket is annular, said positioning of said second end of said flange includes moving said second end through the inside diameter of said gasket into contact with said portion of said gasket seat.

44. A method of inserting a gasket into a hose coupling and positioning the gasket against a gasket seat in the hose coupling, said method comprising:
providing a shaft having a flange attached at one end, said flange including an arced edge and a generally flat bottom surface adjacent said arced edge;
inserting the gasket into an end of the hose coupling;
inserting said shaft into said hose coupling;
moving said generally flat bottom surface of said flange into contact with at least a portion of the gasket; and
pushing the gasket further into the hose coupling with the flange until the gasket abuts the gasket seat.

45. The method of claim 44 further including substantially maintaining said arced edge in contact with an inner surface of the hose coupling while pushing the gasket into the hose coupling.
